(19) United States
(12) Patent Application Publication
(10) Pub. No.: US 2025/0021209 A1
(43) Pub. Date: Jan. 16, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Takuya TOGASHI, Kanagawa (JP)

(73) Assignee: FUJIFILM Business Innovation Corp., Tokyo (JP)

(21) Appl. No.: 18/593,963

(22) Filed: Mar. 3, 2024

(30) Foreign Application Priority Data
Jul. 14, 2023 (JP) 2023-116337

(51) Int. Cl. G06F 3/0482; H04N 1/00

(52) U.S. Cl. CPC G06F 3/0482; H04N 1/00435

(57) ABSTRACT

An information processing system includes a processor configured to, when objects for executing same processing are distributed in a plurality of screens in a hierarchical structure, perform control to change processing to be executed when an object is operated, in accordance with a type of the operated object and a layer of a screen including the operated object.

### CROSS-REFERENCE TO RELATED APPLICATIONS

This application is based on and claims priority under 35 USC 119 from Japanese Patent Application No. 2023-116337 filed Jul. 14, 2023.

### BACKGROUND

### (i) Technical Field

The present disclosure relates to an information processing system and a non-transitory computer readable medium.

### (ii) Related Art

Japanese Unexamined Patent Application Publication No. 2017-187833 discloses an electronic apparatus including a display unit that displays a menu including a plurality of items on a predetermined screen, and when one item is designated on the menu belonging to an n-th layer (n is an integer that is equal to or larger than two), displays on a first screen, the designated item on the menu belonging an upper layer that is an (n−1)-th or higher layer together with the menu belonging to an (n+1)-th layer corresponding to the designated item, and an operation unit that receives an operation on an any screen and the menu.

### SUMMARY

In an information processing system that displays screens in a hierarchical structure, for example, even if a user does not perform an operation of transitioning to a screen located in a lower layer, a function to be executed on the transition destination screen may be executable on another screen such as a preview screen that displays an overview of the screen.

The preview screen is displayed by a relatively simple operation of, for example, holding a mouse on a specific screen for a predetermined time. This means that the user may unintentionally select an object on the preview screen by an erroneous operation, resulting in execution of processing that cannot be cancelled for example.

Thus, displaying of objects for performing the same processing on a plurality of screens leads to a situation in which even when an object included in a specific screen accepts an operation from the user, it is preferable not to execute processing corresponding to the object.

Aspects of non-limiting embodiments of the present disclosure relate to an information processing system and an information processing program capable of suppressing execution of unintended processing due to an erroneous operation by a user as compared with a case where processing associated in advance with the operation of the user can only be executed with objects for executing the same processing that are included in a plurality of screens.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to, when objects for executing same processing are distributed in a plurality of screens in a hierarchical structure, perform control to change processing to be executed when an object is operated, in accordance with a type of the operated object and a layer of a screen including the operated object.

### BRIEF DESCRIPTION OF THE DRAWINGS

Exemplary embodiments of the present disclosure will be described in detail based on the following figures, wherein:

FIG. 1 is a diagram illustrating an example of a configuration of a main part of an information processing system;

FIG. 2 is a diagram illustrating an example of operation on a screen on the image forming apparatus;

FIG. 3 is a diagram illustrating a display example of a preview in a case where a conventional preview function is applied;

FIG. 4 is a flowchart illustrating an example of a flow of operation processing;

FIG. 5 is a flowchart illustrating an example of a flow of acceptability determination processing;

FIG. 6 is a diagram illustrating a display example in a case where a user operation is performed on a start button on a preview;

FIG. 7 is a diagram illustrating a display example in a case where a user operation is performed on an N-up button on the preview;

FIG. 8 is a flowchart illustrating another example of a flow of the operation processing;

FIG. 9 is a diagram illustrating an example of a preview displaying an execution screen for a copy function;

FIG. 10 is a flowchart illustrating another example of a flow of the acceptability determination processing;

FIG. 11 is a diagram illustrating a display example of a screen in a case where an instruction operation is performed on a start button on a preview of a copy screen;

FIG. 12 is a diagram illustrating another display example of a screen in a case where an operation is performed on the start button on the preview of the copy screen;

FIG. 13 is a flowchart illustrating an example of a flow of operation processing according to a fourth exemplary embodiment;

FIG. 14 is a diagram illustrating a display example in a case where an instruction operation is performed by a user on a start button on a preview displaying an execution screen for a copy function;

FIG. 15 is a diagram illustrating a display example in a case where the instruction operation is performed by a user on the start button on the execution screen for the copy function; and

FIG. 16 is a flowchart illustrating an example of a flow of operation processing according to a modification.

### DETAILED DESCRIPTION

Hereinafter, exemplary embodiments of the disclosure will be described with reference to the drawings. Note that the same constituent elements and the same processing are denoted by the same reference signs throughout the drawings, and redundant description is omitted. In addition, dimensional ratios in the drawings are exaggerated for convenience of description and may be different from actual ratios.

### First Exemplary Embodiment

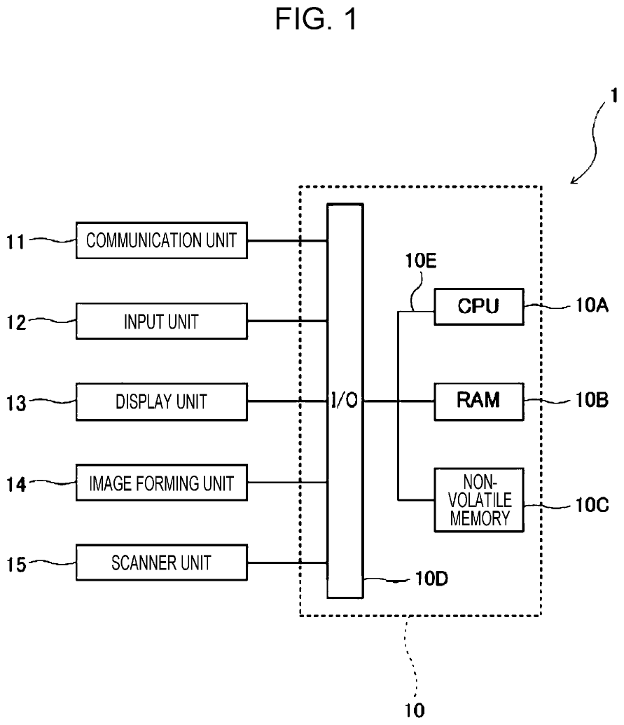

FIG. 1 is a diagram illustrating an example of a configuration of a main part of an information processing system. The information processing system according to the present exemplary embodiment may be any type of system as long as it is a system that displays a screen for providing an interface between the information processing system and a user, and is a system in which screens to be displayed are in a hierarchical structure.

The screens in a hierarchical structure mean that a configuration of the screens is represented by, for example, a tree structure with a certain screen located at the vertex. A node in the tree structure corresponds to each screen, and an edge connecting the nodes in the tree structure represents a transition relationship from one screen to another.

In the present exemplary embodiment, a screen corresponding to the node located at the vertex of the tree structure is referred to as a “top screen”, a screen corresponding to a terminal node reached as a result of proceeding along the edges from the vertex of the tree structure is referred to as a “lowermost layer screen”, and screens other than the top screen and the lowermost layer screen are referred to as “intermediate screens”.

Hereinafter, exemplary embodiments of the information processing system will be described using, as an example, an image forming apparatus 1 that accepts an operation from a user on screens in a hierarchical structure.

The image forming apparatus 1 has a plurality of functions including, for example, a print function of printing the content of a file on a sheet, a scan function of optically reading characters and images on a document, and a copy function of printing the content of the read document on a sheet. For convenience of explanation, printing the content of a file on a sheet is referred to as “printing”.

As illustrated in FIG. 1, the image forming apparatus 1 includes, for example, a computer 10. The computer 10 includes a central processing unit (CPU) 10A which is an example of a processor, a random access memory (RAM) 10B which is used as a temporary work area of the CPU 10A, a non-volatile memory 10C, and an input/output (I/O) interface 10D. The CPU 10A, the RAM 10B, the non-volatile memory 10C, and the I/O 10D are connected to each other via a bus 10E.

For the non-volatile memory 10C which is an example of a storage device in which stored information is retained even after the power supply to the non-volatile memory 10C is turned OFF, a semiconductor memory is used for example. Alternatively, a hard disk may be used. For example, the non-volatile memory 10C stores information that needs to be continuously stored even after the power supply to the image forming apparatus 1 is turned OFF, such as screen-related information.

The non-volatile memory 10C is not necessarily built in the computer 10, and may be, for example, a portable storage device detachable from the computer 10.

For example, a communication unit 11, an input unit 12, a display unit 13, an image forming unit 14, and a scanner unit 15 are connected to the I/O 10D.

The communication unit 11 is connected to a communication line (not illustrated) and has a communication protocol for transmitting and receiving data to and from an external device connected to the communication line. A file to be printed by the image forming apparatus 1 is accepted from, for example, an external device via the communication unit 11.

The input unit 12 is a device that receives an instruction from a user and notifies the CPU 10A of the instruction, and includes, for example, buttons, a touch panel, a mouse, a keyboard, a pointing devices, and the like. The image forming apparatus 1 according to the present exemplary embodiment includes at least a touch panel as the input unit 12.

The display unit 13 is an example of a display device that displays information processed by the CPU 10A as an image, and includes, for example, a liquid-crystal display, an organic electro luminescence (EL) display, and the like. For example, the touch panel, which is an example of the input unit 12, is attached to the display unit 13 in an overlapping manner, and when the user selects an object displayed on the display unit 13 with his or her finger using the touch panel, the CPU 10A is notified of an instruction from the user.

The object is an operator which is displayed on the screen to be an operation target of the user. When operated by the user, the object notifies CPU 10A of the acceptance of the operation from the user. The CPU 10A notified of the operation from the object executes processing associated with the operated object. Therefore, the object includes, for example, a button, a hyperlink, and the like. Hereinafter, an object operation will be described using a button operation as an example.

The image forming unit 14 is a unit that prints the content of a file on a sheet in response to an instruction from the CPU 10A. A printing method in the image forming unit 14 may be any method, and may be, for example, any of an electrophotographic method, an inkjet method, and an offset printing method. The image forming unit 14 is used to execute the print function and the copy function.

The scanner unit 15 is a unit that, in response to an instruction from the CPU 10A, optically reads the content of a document placed on, for example, platen glass and converts the read content of the document into data. The scanner unit 15 is used to execute the scan function and the copy function. Note that the copy function is executed with the CPU 10A causing the image forming unit 14 to print the data obtained by the scanner unit 15 on a sheet.

The functions of the image forming apparatus 1 described above are merely an example, and for example, the image forming apparatus 1 may have a facsimile function of transmitting and receiving image data through a public line and an e-mail function of transmitting and receiving e-mails over the Internet. Furthermore, the image forming apparatus 1 does not needs to have a plurality of functions such as the copy function, the print function, and the scan function, and may have at least one function.

As described above, the information processing system according to the present exemplary embodiment is not limited to the image forming apparatus 1. For example, the system may be applied to any type of device or apparatus with which a user operates screens in a hierarchical structure to issue an instruction, such as a smartphone, a tablet terminal, a car navigation system, or a ticketing machine.

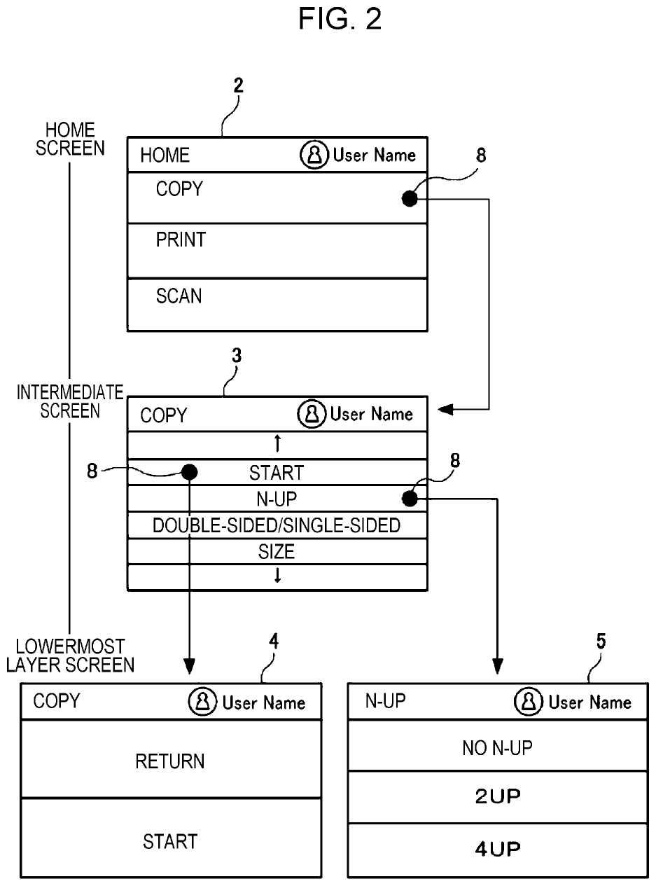

FIG. 2 is a diagram illustrating a screen displayed on the display unit 13 of the image forming apparatus 1 and an example of an operation on the screen.

After the image forming apparatus 1 is activated, a home screen 2 is first displayed as the top screen on the display unit 13.

On the home screen 2, menu buttons with which the user selects a function to be executed are displayed. In the case of the present exemplary embodiment, for example, a copy button, a print button, and a scan button are displayed on the home screen 2.

When the user presses the display unit 13 to which the touch panel is attached using, for example, his or her finger, the CPU 10A performs control to display the next screen associated with the pressed button on the display unit 13 based on the hierarchical structure of the screens. For example, as illustrated in FIG. 2, when the copy button is pressed by the user, the screen displayed on the display unit 13 transitions from the home screen 2 to a copy screen 3.

The copy screen 3 is a screen for setting an operation content related to the copy function. The copy screen 3 includes, for example, a start button for transitioning to an execution screen 4 for executing the copy function based on the operation content set, an N-up button for designating the number of pages to be collectively copied onto one page, a double-sided/single-sided button for designating the side(s) of the document to be read by the scanner unit 15, a size button for designating the size of the sheet to be copied, and the like. Note that when there are too many buttons included in the copy screen 3 to be displayed at once on the copy screen 3, as in the copy screen 3 illustrated in FIG. 2, the CPU 10A displays arrow buttons with arrows such as “↑” and “↓” on the copy screen 3. When the arrow button is pressed by the user, the button CPU 10A displays the buttons included in the copy screen 3 through scrolling in the direction of the arrow indicated by the arrow button.

When the user presses any button other than the arrow buttons included in the copy screen 3, the CPU 10A performs control to display, on the display unit 13, the next screen associated with the pressed button based on the predetermined hierarchical structure of screens. There are screens in a layer lower than the copy screen 3 in the hierarchical structure, meaning that the copy screen 3 is an example of the intermediate screen.

For example, as illustrated in FIG. 2, when the start button is pressed on the copy screen 3, the screen displayed on the display unit 13 transitions from the copy screen 3 to the execution screen 4.

The execution screen 4 is a screen on which the user makes the final decision on whether to execute the copy function. The execution screen 4 includes, for example, a return button for returning to the screen (in this case, the copy screen 3) before the transition to the screen, without executing the copy function, and a start button for executing the copy function. When the user presses the start button on the execution screen 4 to execute the copy function, the user cannot cancel the copy function while the copying is in progress. Thus, the start button on the execution screen 4 is an example of an execution object for executing uncancellable processing.

Further, for example, as illustrated in FIG. 2, when the N-up button is pressed on the copy screen 3, the screen displayed on the display unit 13 transitions from the copy screen 3 to an N-up screen 5.

The N-up screen 5 is a screen on which the user designates the number of pages of the document to be included in one page of the sheet as the destination of the copying. The N-up screen 5 includes, for example, a 1-UP button, 2-UP button, and a 4-UP button with which, when a document is read by the scanner unit 15, one page, two pages, and four pages of the document is/are respectively included in one page of a sheet, as well as the other like buttons. When the user presses any of the buttons included in the N-up screen 5, the number of pages of the document included in one page of the sheet is set. After setting the number of pages of the document to be included in one page of the sheet, the user can transition to a screen transition source (in this case, the copy screen 3) by pressing a return button (not illustrated) on the N-up screen 5, for example, and can press the start button on the copy screen 3 displayed to execute on the execution screen 4, the copy function for collectively copying the set number of pages of document on one page of the sheet.

Thus, since there are no screen of a layer lower than the execution screen 4 or the N-up screen 5 in the hierarchical structure, the execution screen 4 and the N-up screen 5 are examples of the lowermost layer screen.

Note that when the double-sided/single-sided button and the size button on the copy screen 3 are pressed by the user, the screen respectively transitions to a reading side screen (not illustrated) for setting whether both sides or one side of the document are or is to be read by the scanner unit 15, and a size screen (not illustrated) for setting the size of the sheet to be copied. After setting the values in the reading side screen and the size screen, the user presses a return button included in each of the screens to transition to the copy screen 3. Therefore, the reading side screen and the size screen are also examples of the lowermost layer screen.

While the screens in the three layer hierarchical structure in which the screen transitions from the home screen 2 to the copy screen 3 and then transitions from the copy screen 3 to the execution screen 4, the N-up screen 5, the reading side screen, or the size screen are described as an example with reference to FIG. 2, the hierarchical structure of the screens is not limited to the three layers and may include any number of layers not smaller than two.

As described above, there are a plurality of types of buttons included in the screen of the image forming apparatus 1. For example, there is a button, such as the copy button on the home screen 2 that is pressed by the user for the purpose of changing the layer of the screen displayed on the display unit 13 through transition to a screen associated in advance. Hereinafter, the button for transitioning to a screen of a different layer or transitioning to a screen of the same layer is referred to as a “transition button”. The transition button is an example of a transition object that is an object for transitioning to a screen of a different layer or for transitioning to a screen of the same layer.

The transition button includes, for example, a return button for transitioning to a transition source screen, an advance button for transitioning again to a transition destination screen to which the transition has already been made, a login button for transitioning to an authentication screen for authentication for authenticating the user as a user who is permitted to use the image forming apparatus 1 before the user uses the image forming apparatus 1, an update button for displaying the same screen again, and the like.

In addition, there is a button, such as the buttons on the N-up screen 5, pressed by the user for the purpose of setting a value for a designated item. Hereinafter, the button for setting a value for a designated item is referred to as a “setting button”. The setting button is an example of a setting object that is an object for setting a value for a designated item. After the value is set, there is no screen transition destination other than a screen located in the higher layer to be returned, and therefore, the setting button is included in the lowermost layer screen.

The setting button includes a button for setting a reading side of a document for the copy function and a size of a sheet to be a copy destination, a button for setting monochrome printing or color printing, a switching button for switching a character type (for example, a number or an English letters) input by a user, and the like.

In addition, there is a button, such as the start button on the execution screen 4, pressed by the user for the purpose of executing uncancellable processing, that is, irreversible processing. Hereinafter, the button for executing the irreversible processing is referred to as an “execution button”. The execution button is an example of an execution object that is an object for executing the irreversible processing. After the execution of the irreversible processing, there is no screen transition destination other than a screen located at the higher layer to be returned, and therefore, the execution button is included in the lowermost layer screen. The execution button includes, for example, a start button for executing the print function and the scan function, an initialization button for erasing information stored in the non-volatile memory 10C, a login confirmation button for performing login based on information input to the authentication screen, a power button for turning OFF the power supply to the image forming apparatus 1, a power saving button for making the image forming apparatus 1 transition to a power saving mode, and the like.

Although not illustrated in FIG. 2, there is also a button pressed by the user for the purpose of simply displaying information so that the user can confirm the information. Hereinafter, the button for displaying information for the confirmation is referred to as a “confirmation button”. The confirmation button is an example of a confirmation object which is an object for displaying information for confirmation. The confirmation button includes, for example, a button for displaying a serial number of the image forming apparatus 1 and a button for displaying history information in which an event that has occurred in the image forming apparatus 1 is recorded. Information is displayed when the user presses the confirmation button, and therefore, the confirmation button is also a button for executing the irreversible processing, as in the case of the execution button. After the execution of the irreversible processing, there is no screen transition destination other than a screen located at an upper layer to be returned, and therefore, the confirmation button is also included in the lowermost layer screen.

While the example in which the user operates the button by pressing the button is described above, the CPU 10A of the image forming apparatus 1 recognizes that different operations are performed even when the same button is operated, depending on the difference in mode of the pressing on the button by the user.

A black dot 8 on each screen in FIG. 2 indicates a state in which the user has pressed a button arranged at a position where the black dot 8 exists for a predetermined time (for example, 0.5 seconds) or longer. The predetermined time is set to such a time that, if the user presses the button for this time or longer, it can be determined that the user is pressing the button with a clear intention to execute the processing associated with the button. Therefore, the pressing of a button by the user for the predetermined time or longer can be regarded as an operation for executing processing associated with the button. Thus, an operation of causing the CPU 10A to execute original processing associated with each button in advance according to the type of the button, such as screen transition, setting of a value for an item, execution of a function, and confirmation of information, is referred to as a “confirmation operation”.

Meanwhile, when the screens displayed on the display unit 13 are in a hierarchical structure, the user may not know which button should be operated to reach the screen on which the target processing can be executed. In order to alleviate such a concern of the user, a preview function has been conventionally applied in some cases.

The preview function is a function of displaying, on the display unit 13, a transition destination screen as a result of performing the confirmation operation on the button, without the user actually performing the confirmation operation on the button. The preview function enables the user to recognize the transition destination screen to be displayed when the confirmation operation is performed on the button, before actually performing the confirmation operation on the button. Therefore, the user does not have to repeatedly perform the confirmation operation on the button until the user arrives at the screen on which the target processing can be executed, whereby the operability is improved for the user.

The transition destination screen is displayed, for example, to overlap the screen on which the user has performed the operation. A screen on which the transition destination screen associated with the button is thus displayed without the user performing the confirmation operation on the button is referred to as “preview”.

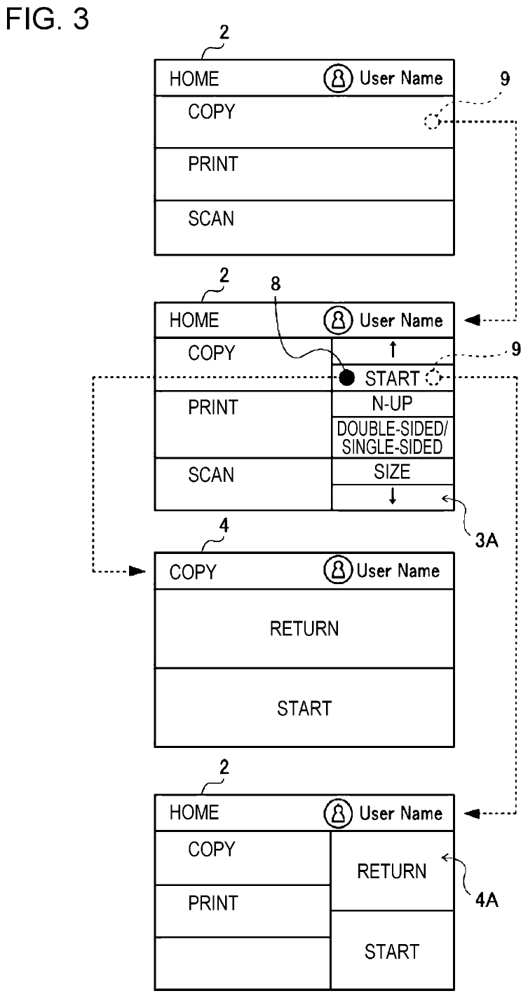

FIG. 3 is a diagram illustrating a display example of the preview in a case where a conventional preview function is applied to the image forming apparatus 1.

A white dot 9 on screens in FIG. 3 indicates a state in which the user has pressed a button arranged at a position where the white circle 9 is located for a time shorter than the predetermined time. When the user presses the button for a time shorter than the predetermined time, a preview displaying the transition destination screen associated with the button is displayed. Thus, an operation of causing the CPU 10A to execute processing of displaying the preview of a screen to be displayed as a result of the confirmation operation on a button without executing the original processing associated with the button in advance is referred to as an “instruction operation”. Hereinafter, the confirmation operation and the instruction operation are simply referred to as “operation” when they need not to be distinguished.

The example in FIG. 3 illustrates a state where the user performs the instruction operation on the copy button on the home screen 2, and then a preview of the copy screen 3 is displayed on the home screen 2. Furthermore, a state is illustrated where the screen transitions to the execution screen 4 when the user performs the confirmation operation on the start button displayed on the preview of the copy screen 3, and the preview of the execution screen 4 is displayed on the home screen 2 when the user performs the instruction operation. Thus, on the preview, the confirmation operation and the instruction operation on the button displayed on the preview are further accepted. When the instruction operation is accepted on the preview, a preview of the transition destination screen associated with the button on which the instruction operation has been performed is further displayed.

As described above, the preview according to the present exemplary embodiment is an example of a simple screen displayed by the instruction operation for confirming the screen content of a layer lower than the screen displayed on the display unit 13. If the preview is also regarded as one independent screen, the preview function makes buttons for executing the same processing dispersedly displayed on a plurality of screens in a hierarchical structure.

Hereinafter, for convenience of description, a preview is denoted by a reference sign obtained by adding “A” added to the end of the reference sign allocated to the screen displayed on the preview. For example, the preview of the copy screen 3 is represented as “preview 3A”, and the preview of the execution screen 4 is represented as “preview 4A”. When description is given without limiting the preview to a preview of a specific screen, the preview is simply referred to as “preview”.

While in the example described herein, the CPU 10A recognizes the difference between the confirmation operation and the instruction operation based on the duration of time for which the user presses the touch panel attached to the display unit 13, the method of recognizing the confirmation operation and the instruction operation differs among the types of the input unit 12 used.

For example, in a case where the user operates a button using a mouse, the CPU 10A recognizes the confirmation operation in response to clicking of a button using the mouse, and recognizes the instruction operation in response to placement of a cursor on the button, that is, mouse-over. Note that the CPU 10A may recognize the confirmation operation in response to double clicking of a button using the mouse, and recognize the instruction operation in response to single clicking on a button using the mouse.

In addition, for example, in a case where the user operates a button using a non-contact panel, CPU 10A recognize the confirmation operation when a finger of the user hovers over the button for a predetermined time or more, and may recognize the instruction operation when the hover time is shorter than the predetermined time. The hover is an operation of fixing a position of a finger in a state where the finger is in the vicinity of a non-contact panel. The operation on the non-contact panel is not necessarily performed by a finger, and may be performed by a body part other than the finger such as, for example, a nose or the like.

In a case where such a conventional preview function is applied to the image forming apparatus 1, when a finger unintentionally touches a preview displayed for confirming the screen content, the CPU 10A may recognize the confirmation operation and processing associated with the button at the position touched by the finger may be executed.

In view of this, the following description is given on operation processing by the image forming apparatus 1, with execution of unintended processing due to an erroneous operation of a user suppressed as compared with a case where the related art preview function is applied to the screen operation.

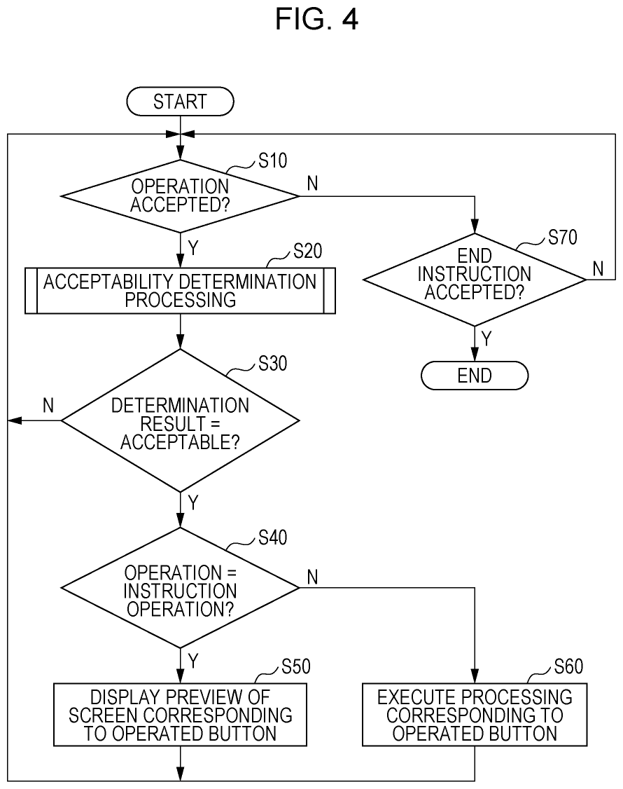

FIG. 4 is a flowchart illustrating an example of a flow of operation processing executed by the CPU 10A of the image forming apparatus 1, with any screen displayed on the display unit 13.

An information processing program defining the operation processing is stored in advance in, for example, the non-volatile memory 10C of the image forming apparatus 1. The CPU 10A of the image forming apparatus 1 reads the information processing program stored in the non-volatile memory 10C and executes the operation processing.

First, in step S10, the CPU 10A determines whether any of the buttons displayed on the screen has accepted any operation. When any of the buttons has accepted any operation, the processing proceeds to step S20.

In step S20, the CPU 10A executes acceptability determination processing for setting whether an operation performed on a button is acceptable. Note that details of the acceptability determination processing will be described later. A determination result indicating acceptable or unacceptable is obtained by the acceptability determination processing.

In step S30, the CPU 10A determines whether the determination result obtained by the acceptability determination processing is acceptable. When the determination result indicates not acceptable, that is, unacceptable, the processing proceeds to step S10. Thus, the CPU 10A does not accept the operation by the user on the button. On the other hand, when the determination result is acceptable, the processing proceeds to step S40.

In this case, since the user operation is acceptable, the CPU 10A executes processing corresponding to the type of the operation. Specifically, in step S40, the CPU 10A determines whether the accepted operation is the instruction operation. When the accepted operation is the instruction operation, the processing proceeds to step S50.

In step S50, the CPU 10A displays a preview of a transition destination screen associated with the button on which the instruction operation has been performed. After the preview is displayed, the processing proceeds to step S10, and the CPU 10A continues to execute the processing of determining whether any of the buttons displayed on the screen has accepted any operation.

On the other hand, when the accepted operation is determined not to be the instruction operation and is determined to be the confirmation operation in the determination processing in step S40, the processing proceeds to step S60.

In step S60, the CPU 10A executes processing associated with a button on which the confirmation operation has been performed. After the defined processing is executed, the processing proceeds to step S10, and the CPU 10A continues to execute the processing of determining whether any of the buttons displayed on the screen has accepted any operation.

When it is determined that none of the buttons has accepted an operation in the determination processing in step S10, the processing proceeds to step S70.

In step S70, the CPU 10A determines whether an end instruction is accepted. The end instruction is an instruction indicating the end of use of the image forming apparatus 1 by the user, and is issued in response to, for example, logout from the image forming apparatus 1 or execution of the confirmation operation on the execution button. When the end instruction is not accepted, which means that the user continues to use the image forming apparatus 1, the processing proceeds to step S10. On the other hand, when the end instruction is accepted, the operation processing illustrated in FIG. 4 ends.

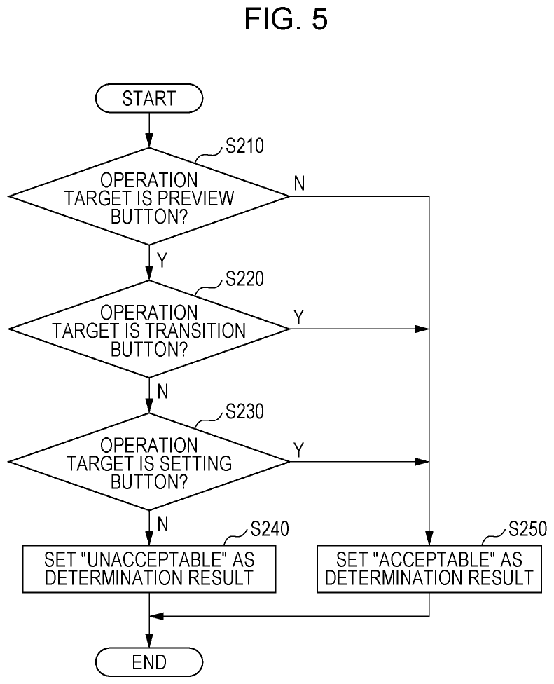

Next, the acceptability determination processing in step S20 will be described. FIG. 5 is a flowchart illustrating an example of a flow of the acceptability determination processing.

In step S210, the CPU 10A determines whether the user operation target is a button on a preview. When the operation target is the button on the preview, the processing proceeds to step S220.

In step S220, the CPU 10A determines whether the type of the button that is the operation target is the transition button. When the operation target is not the transition button, the processing proceeds to step S230.

In step S230, the CPU 10A determines whether the type of the button that is the operation target is the setting button. When the operation target is not the setting button, the processing proceeds to step S240.

In this case, since the type of the button operated by the user is the execution button or the confirmation button included in the preview, in step S240, the CPU 10A sets unacceptable as the determination result, and the processing proceeds to step S30 in FIG. 4. Thus, when the type of the button operated by the user is the execution button or the confirmation button included in the preview, the CPU 10A refuses to accept the user operation.

In other words, since the transition button is included in the intermediate screen, and the execution button and the confirmation button are included in the lowermost layer screen, the CPU 10A not only takes the type of the button into consideration but also takes the layer of the screen into consideration and refuses to accept the user operation by changing the operation to be executed which is otherwise supposed to be one corresponding to the operation.

On the other hand, when it is determined by the determination processing in step S210 that the user operation target is a button on a screen other than the preview, when it is determined by the determination processing in step S220 that the user operation target is the transition button on the preview, and when it is determined by the determination processing in step S230 that the user operation target is the setting button on the preview, the processing proceeds to step S250.

In this case, the type of the button operated by the user is a button on a screen other than the preview, or the transition button or the setting button included in the preview. In step S250, the CPU 10A sets acceptable as the determination result, and the processing proceeds to step S30 in FIG. 4. That is, when the type of the button operated by the user is a button on a screen other than the preview, or is the transition button or the setting button included in the preview, the CPU 10A executes processing corresponding to the operation.

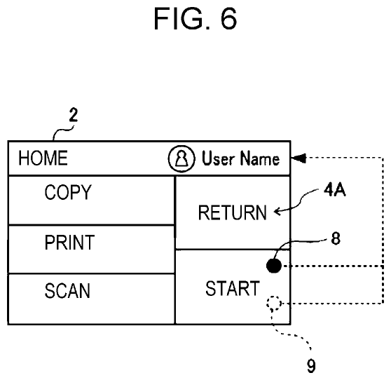

FIG. 6 is a diagram illustrating a display example in a case where a user operation is performed on the start button on the preview 4A displayed to overlap the home screen 2. Since the start button is the execution button, the image forming apparatus 1 does not accept the operation regardless of whether the user operation is the confirmation operation or the instruction operation. Therefore, the same screen is continuously displayed on the display unit 13.

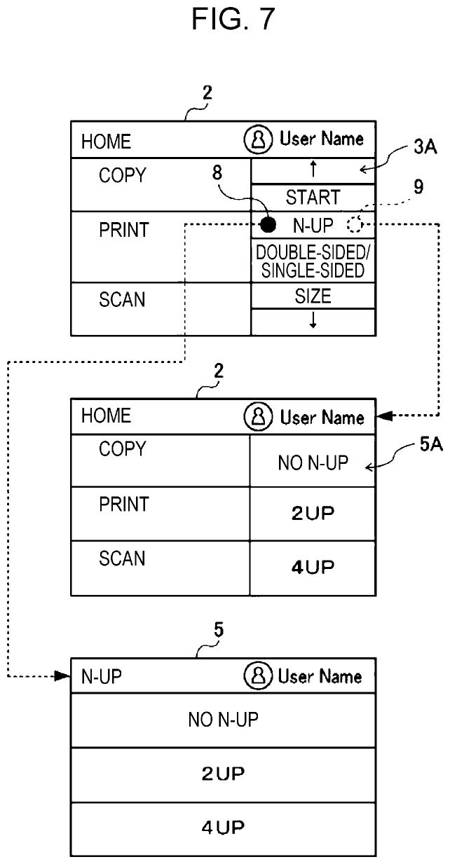

On the other hand, FIG. 7 is a diagram illustrating a display example in a case where a user operation is performed on the N-up button on the preview 3A displayed to overlap the home screen 2. Since the N-up button is a transition button, the image forming apparatus 1 executes processing corresponding to the operation. Specifically, the CPU 10A displays a preview 5A of the N-up screen 5 instead of the preview 3A, when the user operation is the instruction operation. On the other hand, when the user operation is the confirmation operation, the CPU 10A displays the N-up screen 5 in place of the home screen 2.

As described above, the image forming apparatus 1 according to the first exemplary embodiment refuses to accept an operation on the execution button and the confirmation button included in the preview.

### Second Exemplary Embodiment

In the image forming apparatus 1 according to the first exemplary embodiment, the operation on the execution button and the confirmation button included in the preview are not accepted. In a second exemplary embodiment, a description is given on an example of the image forming apparatus 1 that does accept the user operation on the button included in the preview but changes the processing for the instruction operation.

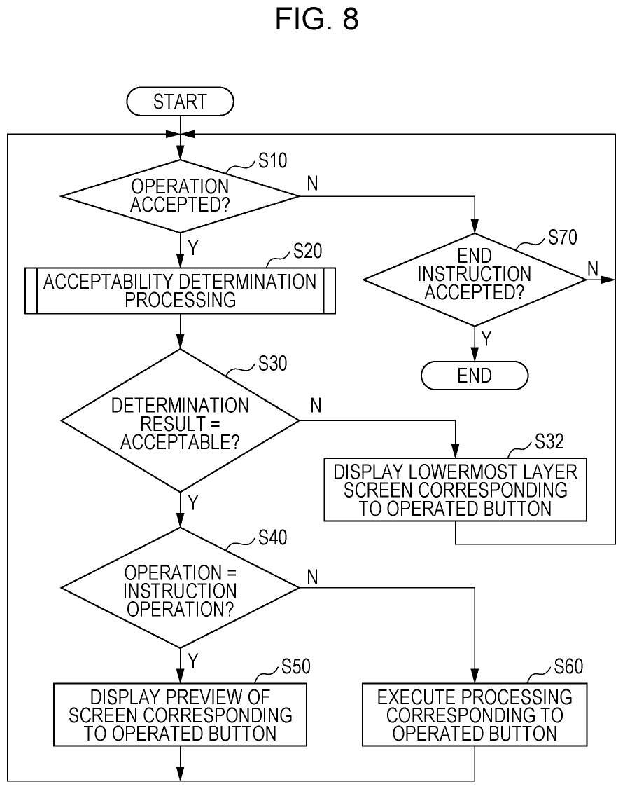

FIG. 8 is a flowchart illustrating an example of a flow of operation processing executed by the CPU 10A of the image forming apparatus 1, with any screen displayed on the display unit 13.

An information processing program defining the operation processing is stored in advance in, for example, the non-volatile memory 10C of the image forming apparatus 1. The CPU 10A of the image forming apparatus 1 reads the information processing program stored in the non-volatile memory 10C and executes the operation processing.

The operation processing illustrated in FIG. 8 is different from the operation processing illustrated in FIG. 4 in that step S32 is added, and the remaining part of the processing is the same. Therefore, in the second exemplary embodiment, the processing in step S32 will be mainly described.

When it is determined in the determination processing in step S30 that the determination result of the acceptability determination processing in step S20 is unacceptable, the processing proceeds to step S32.

In step S32, the CPU 10A displays a lowermost layer screen including a button for executing the same processing as the processing associated with the button (in this case, the execution button and the confirmation button) on the preview on which the instruction operation has been made, and the processing proceeds to step S10.

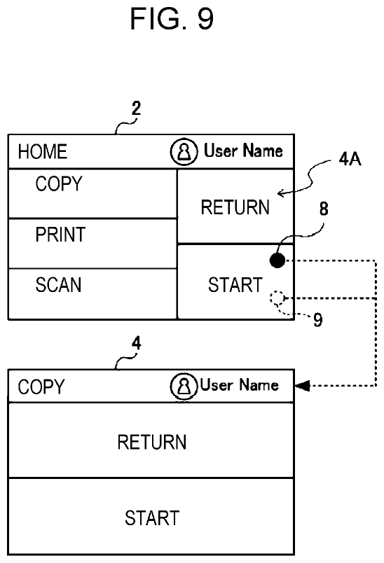

FIG. 9 is a diagram illustrating an example of the preview 4A displaying the execution screen 4 for the copy function. For example, in the operation processing illustrated in FIG. 4, when the user operates the start button on the preview 4A, the operation is not accepted and the preview 4A continues to be displayed as illustrated in FIG. 6. However, in the operation processing illustrated in FIG. 8, the execution screen 4 for the copy function is displayed on the display unit 13 as a result of the processing in step S32. That is, when an operation is performed on a button on the preview on which an operation determined to be unacceptable by the acceptability determination processing has been performed, the CPU 10A independently displays the screen displayed on the preview. Note that as can be understood from the acceptability determination processing illustrated in FIG. 5, an operation that is determined to be unacceptable is an operation on a button included in the preview of the lowermost layer screen, and therefore, the screen displayed by CPU 10A in this case is the lowermost layer screen.

As described above, according to the image forming apparatus 1 of the second exemplary embodiment, for example, an unintended operation by the user in the preview only leads to displaying of the lowermost layer screen including the operated button.

### Third Exemplary Embodiment

In the image forming apparatus 1 according to the first exemplary embodiment and the second exemplary embodiment, the control is performed to change the processing to be executed in response to an operation on the button depending on the type of the button operated on the preview. In a third exemplary embodiment, an example of the image forming apparatus 1 will be described in which processing for the instruction operation is changed depending on the type of a button included in another preview displayed by the instruction operation on a button included in the preview.

The flowchart of the operation processing executed by the image forming apparatus 1 according to the third exemplary embodiment is the same as the flowchart of the operation processing of the image forming apparatus I according to the first exemplary embodiment illustrated in FIG. 4 and the flowchart of the operation processing of the image forming apparatus 1 according to the second exemplary embodiment illustrated in FIG. 8. However, there is a difference in the acceptability determination processing in step S20 in FIGS. 4 and 8. Therefore, in the third exemplary embodiment, the acceptability determination processing will be mainly described.

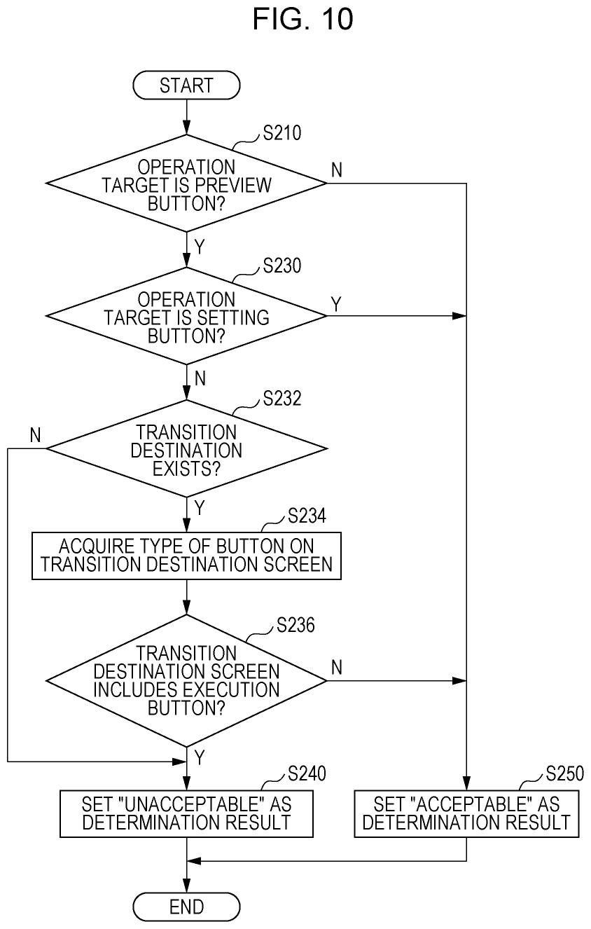

FIG. 10 is a flowchart illustrating an example of the flow of acceptability determination processing executed by the CPU 10A of the image forming apparatus 1 in step S20 of FIGS. 4 and 8. The acceptability determination processing illustrated in FIG. 10 is different from the acceptability determination processing illustrated in FIG. 5 in that step S220 is deleted and steps S232 to S236 are added. The remaining part of the processing is the same. Therefore, in the third exemplary embodiment, the description will be mainly given on the processing in step S232 to step S236.

When it is determined that the operation target of the user is a button on the preview by the determination processing in step S210 of FIG. 10, the processing proceeds to step S230.

When it is determined that the operation target of the user is not the setting button in the preview by the determination processing in step S230, the processing proceeds to step S232.

In step S232, the CPU 10A determines, for the button operated, whether there is a transition destination screen corresponding to the operation. In other words, it is determined whether the screen displayed on the preview is the top screen or the intermediate screen. When there is the transition destination screen, the processing proceeds to step S234.

In step S234, the CPU 10A acquires configuration information of the transition destination screen, and acquires a type of a button included in the transition destination screen. The configuration information of each screen may be stored in advance in, for example, the non-volatile memory 10C.

In step S236, the CPU 10A determines whether a predetermined type of button is included in the transition destination screen, by referring to the type of button included in the transition destination screen acquired in the processing in step S234. While an example in which whether the execution button is included in the transition destination screen is determined as an example of the predetermined type of button will be described herein, a determination on whether the execution button or the confirmation button is included in the transition destination screen may be made. When the execution button is included in the transition destination screen, the processing proceeds to step S240 where the CPU 10A sets unacceptable as the determination result.

On the other hand, when it is determined by the determination processing in step S232 that there is no transition destination screen for the button operated, the processing proceeds to step S234 without executing the processing in step S236 and step S240, and the CPU 10A sets unacceptable as the determination result.

Note that when it is determined that the execution button is not included in the transition destination screen by the determination processing in step S236, the irreversible processing will not be executed even when the transition destination screen is displayed. Therefore, the processing proceeds to step S250 where the CPU 10A sets acceptable as the determination result.

In the operation processing illustrated in FIG. 4, when the acceptability determination processing illustrated in FIG. 10 is applied to the processing in step S20, the image forming apparatus 1 refuses to accept a user operation on the execution button or the confirmation button included in the preview of the lowermost layer screen. Furthermore, also when the execution button is included in the transition destination screen to which the transition occurs in response to an operation on a button included in the preview, the image forming apparatus 1 refuses to accept the user operation.

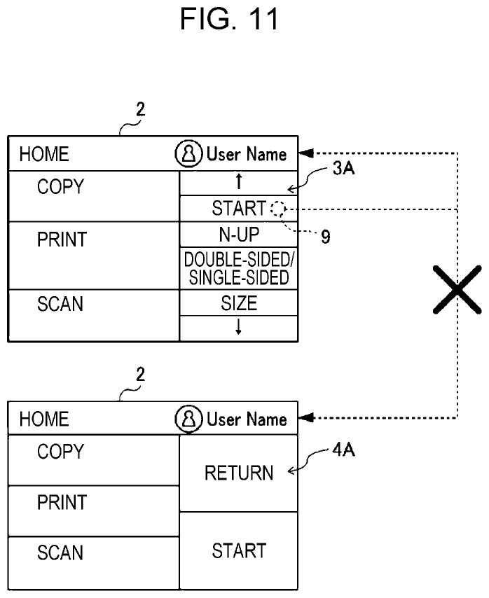

FIG. 11 is a diagram illustrating an example of a screen displayed when the instruction operation is performed on the start button included in the preview 3A under a situation where the acceptability determination processing illustrated in FIG. 10 is applied to step S20 of the operation processing illustrated in FIG. 4.

It is assumed that step S20 of the operation processing illustrated in FIG. 4 is the acceptability determination processing illustrated in FIG. 5 when the instruction operation is performed on the start button on the preview 3A, for example. In this case, since the start button on the preview 3A is a transition button for transitioning to the preview 4A, the preview 4A is displayed.

On the other hand, when the acceptability determination processing illustrated in FIG. 10 is applied to step S20 of the operation processing illustrated in FIG. 4, the preview 4A that is the transition destination screen as a result of the instruction operation on the start button on the preview 3A includes the execution button (to be specific, the start button). Therefore, the image forming apparatus 1 does not display the preview 4A and continues to display the preview 3A.

Furthermore, it is assumed that the acceptability determination processing illustrated in FIG. 10 is applied to step S20 of the operation processing illustrated in FIG. 8. In this case, when the user operated the execution button or the confirmation button included in the preview of the lowermost layer screen, the image forming apparatus 1 displays the lowermost layer screen including the button for executing the same processing as the processing associated with the operation target button, as a result of the processing in step S32 in FIG. 8. Furthermore, also in a case where the execution button is included in the transition destination screen corresponding to the button on the preview operated, the image forming apparatus 1 displays, as a result of the processing in step S32 in FIG. 8, the lowermost layer screen including the button to execute the same processing as the processing associated with the operation target button.

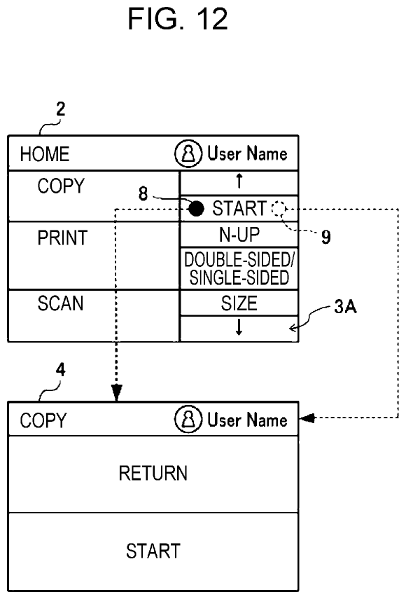

FIG. 12 is a diagram illustrating an example of a screen displayed when an operation is performed on the start button included in the preview 3A under a situation in which the acceptability determination processing illustrated in FIG. 10 is applied to step S20 of the operation processing illustrated in FIG. 8.

In a case where the instruction operation is performed on the start button in the preview 3A, the execution button (specifically, the start button) is included in the preview 4A that is a transition destination screen as a result of the instruction operation the start button on the preview 3A. Therefore, the image forming apparatus 1 does not display the preview 4A, and displays the execution screen 4 including a button to execute the same processing as the processing associated with the start button on the preview 3A.

Note that the image forming apparatus 1 displays the execution screen 4 also in a case where the confirmation operation is performed on the start button in the preview 3A.

As described above, according to the image forming apparatus 1 of the third exemplary embodiment, in a case where a button of a predetermined type is included in another preview displayed as a result of the instruction operation on the button on the preview, control is performed to change the processing corresponding to the instruction operation performed on the button. Specifically, the image forming apparatus 1 does not accept the instruction operation on the execution button or the confirmation button included in the preview. Further, upon receiving the instruction operation on the transition button included on the preview, the image forming apparatus 1 does not display the preview serving as the transition destination when the execution button or the confirmation button is included in the transition destination screen.

### Fourth Exemplary Embodiment

The image forming apparatus 1 in the above described example performs control to disable execution of the same irreversible processing from a plurality of screens without disabling the preview function, by making the irreversible processing executed on the lowermost layer screen and not on the preview including the button for executing the irreversible processing.

In the fourth exemplary embodiment, an image forming apparatus 1 will be described in which, when the instruction operation is performed on a button included in a lowermost layer screen and a preview displaying the lowermost layer screen, information regarding an execution result as a result of execution of processing as a result of the confirmation operation is displayed, to warn the user not to perform an erroneous operation.

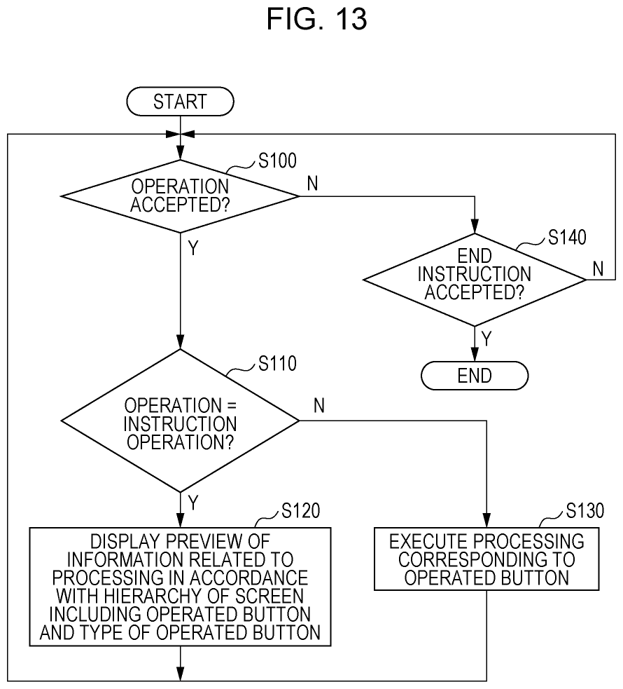

FIG. 13 is a flowchart illustrating an example of a flow of operation processing executed by the CPU 10A of the image forming apparatus 1 when any screens is displayed on the display unit 13.

An information processing program defining the operation processing is stored in advance in, for example, the non-volatile memory 10C of the image forming apparatus 1. The CPU 10A of the image forming apparatus 1 reads the information processing program stored in the non-volatile memory 10C and executes the operation processing.

First, in step S100, the CPU 10A determines whether any of the buttons displayed on the screen has accepted any operation. When any of the buttons has accepted any operation, the processing proceeds to step S110.

In step S110, the CPU 10A determines whether the accepted operation is the instruction operation. When the accepted operation is the instruction operation, the processing proceeds to step S120.

In step S120, the CPU 10A displays a preview of processing related information, in accordance with the layer of the screen including the operated button and the type of the button operated.

For example, when the instruction operation is performed on a button included in the lowermost layer screen, the CPU 10A changes information to be displayed on the preview depending on the type of the button on which the instruction operation has been performed.

Specifically, if the type of the button on which the instruction operation has been performed is the transition button, the CPU 10A displays a preview of the transition destination screen associated with the transition button.

When the type of the button on which the instruction operation has been performed is the setting button, the CPU 10A displays a preview displaying a description related to the setting item.

When the type of the button on which the instruction operation has been performed is the execution button, the CPU 10A displays, in accordance with the content of the processing to be executed by the execution button, information related to an execution result to be obtained by the processing executed, on the preview.

For example, when the instruction operation is performed on the execution button for the print function, the CPU 10A displays, for example, a schematic of an image printed on a sheet on the preview so that a situation after the printing can be recognized. When the instruction operation is performed on the execution button for the scan function, the CPU 10A displays, for example, an animation simulating a reading result of a document read by the scanner unit 15 on the preview. The reading result of the document is displayed by the animation due to the absence of the actual data of the document read since the document is not yet read by the scanner unit 15. The CPU 10A refers to the setting content set on a scanner screen (not illustrated) for setting the operation content related to the scan function, for displaying the animation simulating the reading result of the document on the preview. For example, when a setting for reading a document in color is made, the CPU 10A displays a document portion of the animation simulating the reading result of the document in color. Further, when the instruction operation is performed on the power saving button for making the image forming apparatus 1 transition to the power saving mode, the CPU 10A displays, for example, the amount of power that can be saved per unit time and functions that can be used even under the power saving, on the preview. When the instruction operation is performed on the initialization button for initializing a setting value set for defining various operations of the image forming apparatus 1, the CPU 10A displays, for example, for which of the items, the setting value is to be initialized, on the preview. Furthermore, when the instruction operation is performed on a login button, the CPU 10A displays, for example, the authentication screen to be displayed after login, on the preview.

When the type of the button on which the instruction operation has been performed is the confirmation button, the CPU 10A displays on the preview, the information related to the execution result obtained when the processing is executed, in accordance with the content of the information displayed by the confirmation button.

For example, when the instruction operation is performed on the confirmation button for displaying the serial number of the image forming apparatus 1, the CPU 10A displays a description indicating what kind of information the serial number is on the preview.

After executing the processing in step S120, the processing proceeds to step $100, and the CPU 10A continues to execute the processing of determining whether any of the buttons displayed on the screen has accepted any operation.

On the other hand, when it is determined in the determination processing in step S110 that the accepted operation is not the instruction operation, that is, when it is determined that the accepted operation is the confirmation operation, the processing proceeds to step S130.

In step S130, the CPU 10A executes processing associated with the operated button. After executing the processing in step S130, the processing proceeds to step S100, and the CPU 10A continues to execute the processing of determining whether any of the buttons displayed on the screen has accepted any operation.

When it is determined that none of the buttons has accepted an operation in the determination processing in step S100, the processing proceeds to step S140. In step S140, the CPU 10A determines whether the end instruction is accepted. When the end instruction is not accepted, which means that the user continues to use the image forming apparatus 1, the processing proceeds to step S100. On the other hand, when the end instruction is accepted, the operation processing illustrated in FIG. 13 ends.

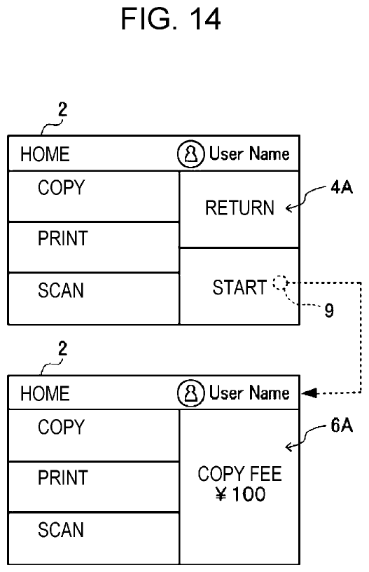

FIG. 14 is a diagram illustrating a display example in a case where the instruction operation is performed by the user on the start button on the preview 4A displaying the execution screen 4 for the copy function to overlap the home screen 2. Since the start button displayed on the preview 4A is the execution button on the lowermost layer screen, the CPU 10A displays, for example, a copy fee on a preview 6A so that the situation after copying can be recognized.

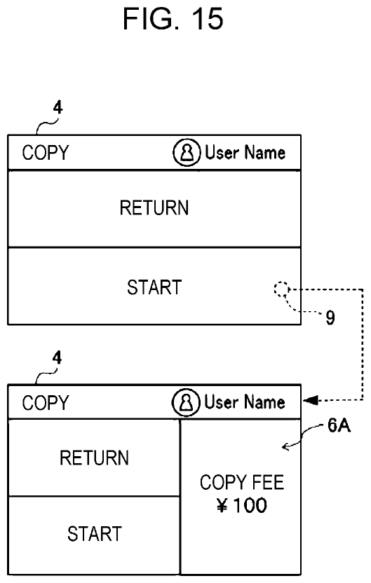

FIG. 15 is a diagram illustrating a display example when the instruction operation is performed by the user on the start button on the execution screen 4 for the copy function. Since the start button for the execution screen 4 is the execution button on the lowermost layer screen, also in this case, the CPU 10A displays, for example, a copy fee on the preview 6A so that the situation after copying can be recognized.

As described above, according to the image forming apparatus 1 of the fourth exemplary embodiment, when the instruction operation is performed on the button included in the lowermost layer screen, the information on the execution result after the processing is executed in response to the confirmation operation on the same button is displayed on the preview.

### Modification

As described above, when the acceptability determination processing illustrated in FIG. 5 or 10 is used for step S20 of the operation processing illustrated in FIG. 4, the image forming apparatus 1 does not accept a user operation on the button for executing the irreversible processing included in the preview of the lowermost layer screen. In this case, the display is not switched even though the operation is performed. Thus, some users may be concerned that some kind of abnormality has occurred in the image forming apparatus 1.

Therefore, when refusing the acceptance of the user operation, the image forming apparatus 1 preferably performs control to notify the user of the intentional refusal of the user's operation.

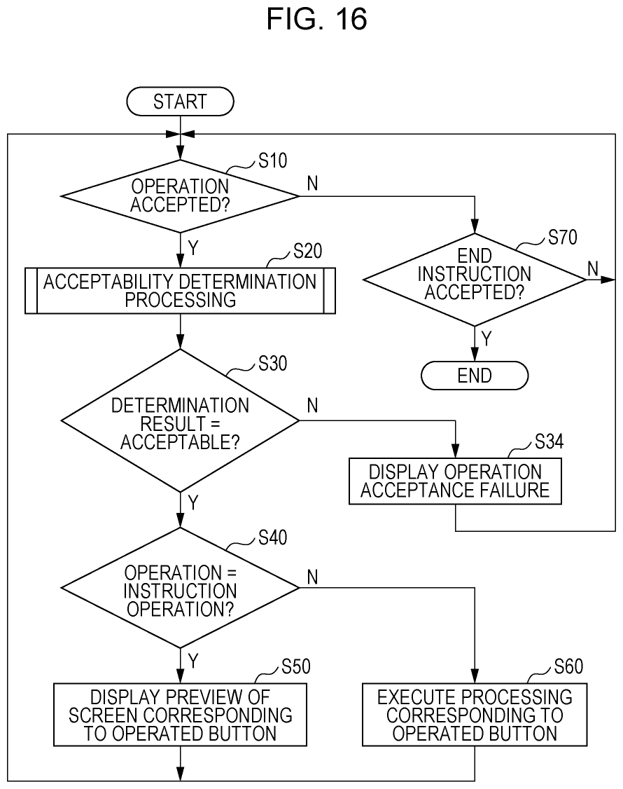

FIG. 16 is a flowchart illustrating an example of a flow of operation processing executed by the CPU 10A of the image forming apparatus 1 when any of the screens is displayed on the display unit 13.

An information processing program defining the operation processing is stored in advance in, for example, the non-volatile memory 10C of the image forming apparatus 1. The CPU 10A of the image forming apparatus 1 reads the information processing program stored in the non-volatile memory 10C and executes the operation processing.

The operation processing illustrated in FIG. 16 is different from the operation processing illustrated in FIG. 4 in that step S34 is added, and the remaining part of the processing is the same. Therefore, the processing in step S34 will be mainly described. The acceptability determination processing in any of FIGS. 5 and 12 may be applied to the acceptability determination processing in step S20 in FIG. 16.

When it is determined in the determination processing in step S30 in FIG. 16 that the determination result of the acceptability determination processing in step S20 is unacceptable, the processing proceeds to step S34. The determination result of the acceptability determination processing in step S20 being unacceptable means that the acceptance of the user operation is refused.

Therefore, in step S34, the CPU 10A displays a message such as “invalid operation” on the display unit 13 to notify the user of the refusal of the acceptance of the operation for example. In this case, the CPU 10A may notify the user of the refusal of the acceptance of the operation, using a buzzer sound or light in addition to the display of the message or instead of the display of the message. Furthermore, the CPU 10A may also issue a notification indicating a solution such as “please perform operation on screen other than preview” for example.

While one mode of the image forming apparatus 1 is described above using the exemplary embodiments, the disclosed mode of the image forming apparatus 1 is an example, meaning that the mode of the image forming apparatus 1 is not limited to the scope described in the exemplary embodiment. Various modifications or improvements can be added to the exemplary embodiment without departing from the spirit and scope of the present disclosure, and modes as a result of the modifications or improvements are also included in the technical scope of the disclosure.

For example, the order of internal processing in the operation processing illustrated in FIGS. 4, 8, and 16 and the acceptability determination processing illustrated in FIGS. 5 and 10 (hereinafter referred to as “each processing”) may be changed without departing from the spirit and scope of the present disclosure.

In the above-described exemplary embodiment, as an example, a mode in which each processing is realized by software processing is described. However, processing equivalent to the flowchart of the each processing may be processed by hardware. In this case, processing speed is increased as compared with a case where each processing is implemented by software processing.

In the above exemplary embodiment, the processor is a processor in a broad sense, and includes a general-purpose processor (for example, the CPU 10A) and a dedicated processor (for example, a Graphics Processing Unit (GPU), Application Specific Integrated Circuit (ASIC), Field Programmable Gate Array (FPGA), a programmable logic device, or the like).

The operation of the processor in the above-described exemplary embodiment may be performed not only by one processor but also by a plurality of processors located at physically separated positions and cooperating with each other. Furthermore, the order of the operations of the processor is not limited to the order described in the above exemplary embodiment only, and may be appropriately changed.

Furthermore, while the “system” according to the present exemplary embodiment is described as being formed by a single apparatus in one example, the “system” may be formed by a plurality of apparatuses.

In the above exemplary embodiment, an example in which the information processing program is stored in the non-volatile memory 10C is described. However, the location where the information processing program is stored is not limited to the non-volatile memory 10C. The information processing program of the present disclosure can also be provided in a mode of being recorded in a storage medium readable by the computer 10.

For example, the information processing program may be provided in a mode of being recorded in an optical disc such as a compact disk read only memory (CD-ROM), a digital versatile disk read only memory (DVD-ROM), and a Blu-ray disc. Further, the control program may be provided in a mode of being recorded in a portable semiconductor memory such as a universal serial bus (USB) memory and a memory card. The non-volatile memory 10C, CD-ROM, DVD-ROM, Blu-ray disc, USB, and memory card are examples of a non-transitory storage medium.

Further, the image forming apparatus 1 may download the information processing program from an external device connected to a communication line through the communication unit 11, and store the downloaded information processing program in the non-volatile memory 10C of the image forming apparatus 1. In this case, the CPU 10A of the image forming apparatus 1 reads the information processing program downloaded from the external device, from the non- volatile memory 10C and executes each processing.

Appendix according to the present exemplary embodiment will be given below.

(((1))) An information processing system comprising:
a processor configured to:
   when objects for executing same processing are distributed in a plurality of screens in a hierarchical structure, perform control to change processing to be executed when an object is operated, in accordance with a type of the operated object and a layer of a screen including the operated object.

(((2))) The information processing system according to (((1))), wherein the processor is configured to, when the screen including the operated object is a simple screen displayed by an instruction operation which is an operation for confirming a screen content of a lower layer and the operated object is an execution object for executing uncancellable processing, perform the control to change the processing to be executed when the object is operated.

(((3))) The information processing system according to (((2))), wherein the processor is configured to refuse to accept an operation on an object by a user.

(((4))) The information processing system according to (((3))), wherein the processor is configured to perform control to notify the user of the refusal to accept the operation on the object by the user.

(((5))) The information processing system according to (((2))), wherein the processor is configured to perform control to display a lowermost layer screen including an object for executing same processing as the operated object.

(((6))) The information processing system according to (((1))), wherein the processor is configured to, when a screen including an operation target object is a simple screen displayed by an instruction operation which is an operation for confirming a screen content of a lower layer, and an object of a predetermined type is included in another simple screen displayed by the instruction operation on an object on the simple screen, perform control to change processing in response to the instruction operation performed on the object.

(((7))) The information processing system according to (((6))), wherein the processor is configured to perform control not to display the other simple screen in response to the instruction operation on the object.

(((8))) The information processing system according to (((6))), wherein the processor is configured to perform control to display a lowermost layer screen including an object for executing same processing as the object on which the instruction operation has been performed.

(((9))) The information processing system according to (((7))) or (((8))), wherein the object on which the instruction operation has been performed is an execution object for executing uncancellable processing.

(((10))) The information processing system according to (((1))), wherein the processor is configured to, when an instruction operation which is an operation for confirming a screen content of a lower layer is performed on an object included in a screen of a lowermost layer in the hierarchical structure, perform control to change processing to be executed in response to the instruction operation, in accordance with a type of the object on which the instruction operation has been performed.

(((11))) The information processing system according to (((10))), wherein the processor is configured to, when the object on which the instruction operation has been performed is an execution object for executing uncancellable processing, perform control to display information related to an execution result obtained when the processing is executed.

(((12))) A program causing a computer to execute a process for information processing the process comprising:
performing, when objects for executing same processing are distributed in a plurality of screens in a hierarchical structure, control to change processing to be executed when an object is operated, in accordance with a type of the operated object and a layer of a screen including the operated object.

What is claimed is:

1. An information processing system comprising:
a processor configured to: when objects for executing same processing are distributed in a plurality of screens in a hierarchical structure, perform control to change processing to be executed when an object is operated, in accordance with a type of the operated object and a layer of a screen including the operated object.

2. The information processing system according to claim 1, wherein the processor is configured to, when the screen including the operated object is a simple screen displayed by an instruction operation which is an operation for confirming a screen content of a lower layer and the operated object is an execution object for executing uncancellable processing, perform the control to change the processing to be executed when the object is operated.

3. The information processing system according to claim 2, wherein the processor is configured to refuse to accept an operation on an object by a user.

4. The information processing system according to claim 3, wherein the processor is configured to perform control to notify the user of the refusal to accept the operation on the object by the user.

5. The information processing system according to claim 2, wherein the processor is configured to perform control to display a lowermost layer screen including an object for executing same processing as the operated object.

6. The information processing system according to claim 1, wherein the processor is configured to, when a screen including an operation target object is a simple screen displayed by an instruction operation which is an operation for confirming a screen content of a lower layer, and an object of a predetermined type is included in another simple screen displayed by the instruction operation on an object on the simple screen, perform control to change processing in response to the instruction operation performed on the object.

7. The information processing system according to claim 6, wherein the processor is configured to perform control not to display the other simple screen in response to the instruction operation on the object.

8. The information processing system according to claim 6, wherein the processor is configured to perform control to display a lowermost layer screen including an object for executing same processing as the object on which the instruction operation has been performed.

9. The information processing system according to claim 7, wherein the object on which the instruction operation has been performed is an execution object for executing uncancellable processing.

10. The information processing system according to claim 8, wherein the object on which the instruction operation has been performed is an execution object for executing uncancellable processing.

11. The information processing system according to claim 1, wherein the processor is configured to, when an instruction operation which is an operation for confirming a screen content of a lower layer is performed on an object included in a screen of a lowermost layer in the hierarchical structure, perform control to change processing to be executed in response to the instruction operation, in accordance with a type of the object on which the instruction operation has been performed.

12. The information processing system according to claim 11, wherein the processor is configured to, when the object on which the instruction operation has been performed is an execution object for executing uncancellable processing, perform control to display information related to an execution result obtained when the processing is executed.

13. A non-transitory computer readable medium storing a program causing a computer to execute a process for information processing, the process comprising:
performing, when objects for executing same processing are distributed in a plurality of screens in a hierarchical structure, control to change processing to be executed when an object is operated, in accordance with a type of the operated object and a layer of a screen including the operated object.
